(19) United States
(12) Patent Application Publication
(10) Pub. No.: US 2013/0092843 A1
(43) Pub. Date: Apr. 18, 2013

(54) Miniature Radiation Detector Module Configured as Smart Mobile Device/Phone Ad-On

(71) Applicants: Marcos de Azambuja Turqueti, Vista, CA (US); Guilherme Cardoso, Carlsbad, CA (US)

(72) Inventors: Marcos de Azambuja Turqueti, Vista, CA (US); Guilherme Cardoso, Carlsbad, CA (US)

(21) Appl. No.: 13/356,640

(22) Filed: Jan. 23, 2012

Related U.S. Application Data
(60) Provisional application No. 61/548,718, filed on Oct. 18, 2011.

(51) Int. Cl. G01T 7/00

(52) U.S. Cl. CPC G01T 7/00
USPC 250/369; 250/336.1; 250/370.13; 250/390.01; 250/394

(57) ABSTRACT

A smart device “plug-in” radiation module(s) and/or methods are described wherein the bulk of non-sensor radiation circuitry is off-loaded to the smart device. By attaching the radiation module to the smart device via a power/communication port (for example, the smart device's headphone/microphone jack) robust attachment can be achieved as well as uniformity of attachment across different smart devices. A very small radiation module form factor is obtainable, not to mention a very significant cost reduction, allowing widespread adoption of radiation detectors as well as radiation geo-mapping. Power for the radiation module can be obtained from the smart device's headphone plug, utilizing the audio out (speaker) signal's power. Similarly, input to the smart device can be facilitated via the audio in (microphone) signal. Further, output of the radiation module can be visualized on the smart device, as well as control functions.

### CROSS-REFERENCE TO RELATED APPLICATION(S)

This application claims the benefit of U.S. Provisional Patent Application No. 61/548,718, filed Oct. 18, 2011, the contents of which are hereby incorporated by reference in its entirety.

### FIELD

This invention relates to portable radiation detectors. More particularly, it relates to portable radiation detectors in conjunction with a smart device, the smart device providing the backbone of the processing, the user interface, and/or the power.

### BACKGROUND

Radiation detectors require the use of a radiation sensor, one that usually requires a specialized type of power, the power (when of a mobile configuration) originating from some battery source or equivalent. The output of the radiation sensor is then processed by a computer/on-board processor and provided to the user in some format, typically as numerals displayed on an LCD display indicating the amount of radiation detected. Reformatting the output information or the operation of the radiation detector requires some means of inputting control signals to the device, typically in the form of buttons or menu selectors. Therefore, most all radiation detectors are computerized, having a processor and display controlling circuitry, resulting in the prices of these units to be several hundreds of dollars at a minimum as well as having a form factor that is not trivial.

Accordingly, there has been a long standing need in the detector community for radiation detectors that are more cost-effective and of a convenient form factor. Details of methods and systems to address these and other deficiencies in the prior art are presented in the following description.

### SUMMARY

The following presents a simplified summary in order to provide a basic understanding of some aspects of the claimed subject matter. This summary is not an extensive overview, and is not intended to identify key/critical elements or to delineate the scope of the claimed subject matter. Its purpose is to present some concepts in a simplified form as a prelude to the more detailed description that is presented later.

A smart device “plug-in” radiation module(s) and/or methods are described, whereas the bulk of non-sensor circuitry is off-loaded to the smart device. By attaching the radiation module to the smart device via the smart device's headphone/microphone jack, a robust attachment can be achieved. By off-loading the non-sensor circuitry, a smaller form factor for the radiation module can be achieved, not to mention a very significant cost reduction, allowing widespread adoption of exemplary radiation detectors. Further, in some instances, power for the radiation module can be exclusively obtained from the smart device's headphone plug, utilizing the audio out (speaker) signal's power. Similarly, input data into the smart device can be facilitated via the audio in (microphone) signal. Further, output of the radiation module can be visualized on the smart device, as well as control functions. Use of the audio jack further allows uniformity of attachment across different smart devices. Geo-mapping of radiation can be achieved using a plurality of smart devices (e.g., mobile phones) with the radiation modules plugged therein.

In one aspect, a radiation detector, capable of being plugged into a smart device's headphone/microphone jack is provided, comprising: a headphone/microphone plug having at least sound-out, ground, and sound-in contacts; an audio signal conditioning/rectifying circuit coupled at least to the sound-out and ground contacts; a high voltage source coupled to an output of the audio signal conditioning/rectifying circuit; a radiation sensor coupled to an output of the high voltage source; a pre-amplifier coupled to an output of the radiation sensor; a energy detector coupled to an output of the pre-amplifier; an impedance matcher coupled to an output of the energy detector, wherein an output of the impedance matcher is coupled to the sound-in contact of the headphone/microphone plug.

In yet another aspect, a portable radiation detection system is provided, comprising: a plurality of radiation detectors capable of being plugged into a portable smart device's headphone/microphone jack, each radiation detector comprising: a headphone/microphone plug, extending from the housing, having at least sound-out, ground, and sound-in contacts; an audio signal conditioning/rectifying circuit coupled at least to the sound-out and ground contacts; a high voltage source coupled to an output of the audio signal conditioning/rectifying circuit enclosed; a radiation sensor coupled to an output of the high voltage source; a pre-amplifier coupled to an output of the radiation sensor; a energy detector coupled to an output of the pre-amplifier; an impedance matcher coupled to an output of the energy detector, wherein an output of the impedance matcher is coupled to the sound-in contact of the headphone/microphone plug; a plurality of smart devices, wherein each of the plurality of radiation detector is plugged into each of the plurality of smart devices; and a radiation detector application running on each of the plurality of smart devices.

Various other aspects of the disclosed embodiments include any one or more of: an independent power source coupled to an input of at least one of the audio signal conditioning/rectifying circuit and the high voltage source; the independent power source is rechargeable; a post detection/conditioning module coupled to an output of the energy detector; the post detection/conditioning module contains at least one of an amplifier, a processor, and a memory; a wireless communication module coupled to the output of at least one of the energy detector and post detection/conditioning module; the elements are analog devices; the radiation sensor is at least one of a CZT, Geiger, neutron, H³, scintillator, PIN, gas, and photo-multiplier sensor; a smart device, wherein the radiation detector is plugged into the smart device via the smart device's headphone/microphone jack; a smart device radiation detector application, running on the smart device and interfacing with data from the radiation detector; the radiation detector is mounted on a back portion of the smart device; the radiation sensor is adapted to be coupled to a secondary device, the secondary device mating to a portion of the housing; the secondary device contains a speaker; the housing is in at least two separate independent pieces; the two separate housing pieces contains the headphone/microphone jack and wherein the other of the two separate housing pieces contains the radiation sensor; there are a plurality of radiation sensors; and at least one of the plurality of radiation sensors is in a housing substantially shaped as a wand.

To the accomplishment of the foregoing and related ends, certain illustrative aspects are described herein in connection with the following description and the annexed drawings. These aspects are indicative, however, of but a few of the various ways in which the principles of the claimed subject matter may be employed and the claimed subject matter is intended to include all such aspects and their equivalents. Other advantages and novel features may become apparent from the following detailed description when considered in conjunction with the drawings. As such, other aspects of the disclosure are found throughout the specification.

### BRIEF DESCRIPTION OF THE DRAWINGS

FIGS. 1A-B are illustrations of a prior art radiation detector.

FIGS. 2A-B are illustrations of a prior art portable smart device.

FIG. 3A is an illustration of a typical four conductor plug.

FIG. 4 is an illustration of an exemplary radiation detector module installed into a smart device's “headphone” jack.

FIGS. 5A-B are a block diagrams of exemplary radiation detectors' circuit layout.

FIG. 6 is an “inside” illustration of an exemplary radiation detector module.

FIGS. 7A-B are illustrations of possible variations of exemplary radiation detectors.

FIGS. 8A-B are illustrations of smart devices in operation with an exemplary radiation detector(s) plugged into the smart devices.

FIGS. 9A-D are illustrations of other configurations for an exemplary radiation detector(s).

FIGS. 10A-D are illustrations of various exemplary radiation detectors and their possible form factors, as-connected to smart devices.

FIGS. 11A-B are illustrations of other exemplary radiation detectors.

FIG. 12 is an illustration of an exemplary radiation detector with sensors deployed about a person's body.

FIG. 13 is an illustration of a geo-locating scenario utilizing exemplary radiation detector systems with smart devices.

### DETAILED DESCRIPTION

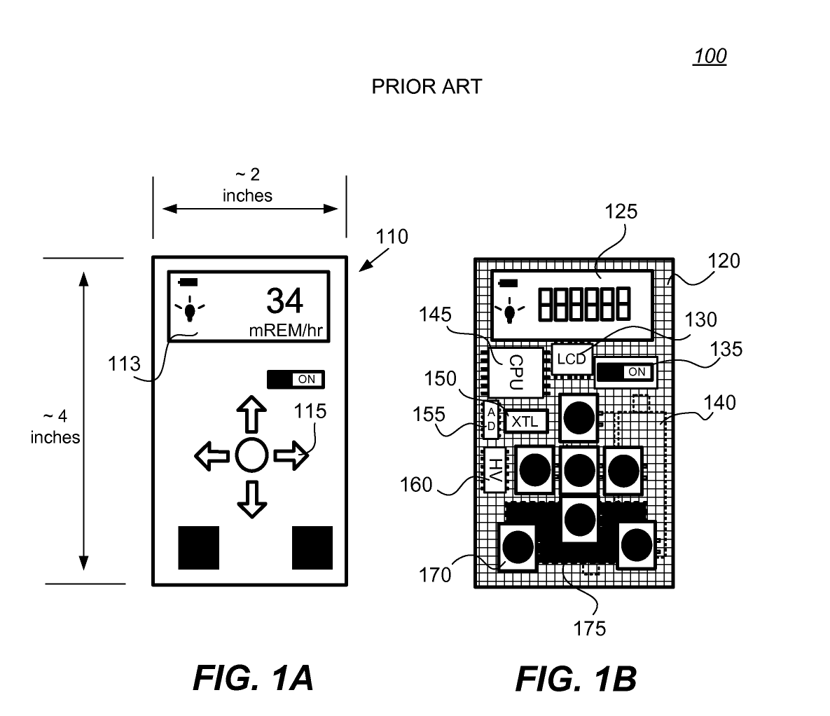

FIGS. 1A-B are illustrations of a prior art radiation detector, whereas FIG. 1A shows an outside view of the portable radiation detector 110, and FIG. 1B shows the board-level layout. Evident from FIG. 1A is the “portable” size of approximately 2 inches (wide) by 4 inches (high) dimensions for such a unit, containing a readout and control buttons 113 and 115, respectively. FIG. 1B shows a board level view with board 120 with LCD readout 125, LCD driver chip 130, power switch 135, battery 140, main CPU 145, crystal/clock 150, Analog-to-Digital (A/D) converter 155, High Voltage chip 160, user control buttons 170, and radiation sensor element 175. As evident, several “chips” are needed for interfacing with the user and converting the radiation sensor element's 175 output to a readable form. All these “chips” result in a significant investment of hardware into the portable prior art radiation detector 110.

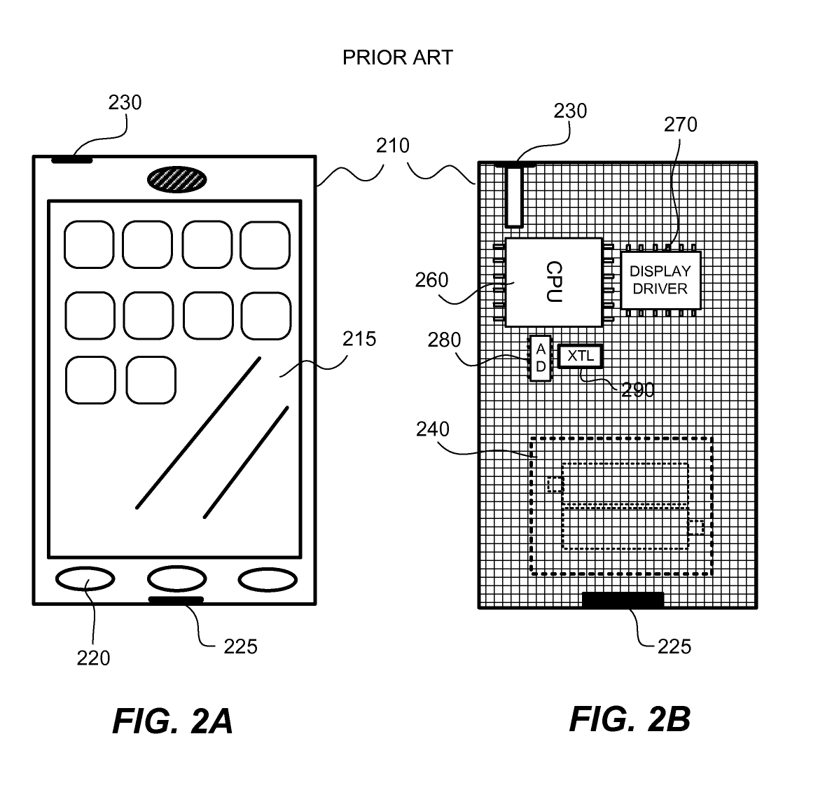

FIGS. 2A-B are illustrations of a prior art portable smart device, with FIG. 2A showing an outside view and FIG. 2B showing a partial inside view. FIG. 2A's view shows the smart device 210 as a smart phone, but may be any smart device, including a tablet, etc. with a touch sensitive display screen 215, dedicated user input buttons 220, main power/communications port 225 and headphone jack 230. It is understood that smart devices, in the context of this disclosure, are inherently “portable.”

FIG. 2B's “inside” view is limited to only show relevant hardware elements of the smart device 210, specifically, main power/communications port 225, headphone jack 230, battery power 240, main CPU 260, display driver 270, A/D converter 280, and crystal/clock 290.

It is noted that a large bulk of “computing/controlling” hardware found in the prior art portable radiation detector of FIG. 1B is also found in the smart device 210. Accordingly, many of the elements needed in the prior art portable radiation detector of FIG. 1B are already replicated in the smart device 210.

Two physical data ports are shown in FIG. 2B, specifically main power/communications port 225 and headphone jack 230. While power/communications port 225 provides digital data channels (as compared to headphone jack 230), it is known that most of these main power/communications ports 225 in smart devices are proprietary or vary between vendors and make. Accordingly, there is a great deal of non-conformity of connector type across different vendors. For example, Apple® uses an “iPod” connector, while Android® devices use a USB style connector, generally of the micro/mini USB form factor, with other phones/devices using standard USB. Accordingly, it is evident that there are a large variety of connector form factors across the different smart devices. Further, it is understood that the main power/communications port 225 is not designed to physically support or retain a cable that is plugged into it. That is, it only takes a slight bit of force to insert or remove a cable or device that is inserted into the main power/communications port 225.

In contrast, the headphone jack 230 is understood to be relatively robust in retaining a device/headphone plug that is plugged into the headphone jack 230. Further, it is well known that the headphone jack 230 configuration is relatively common across all of the smart device vendors, having only simple standard inputs and outputs.

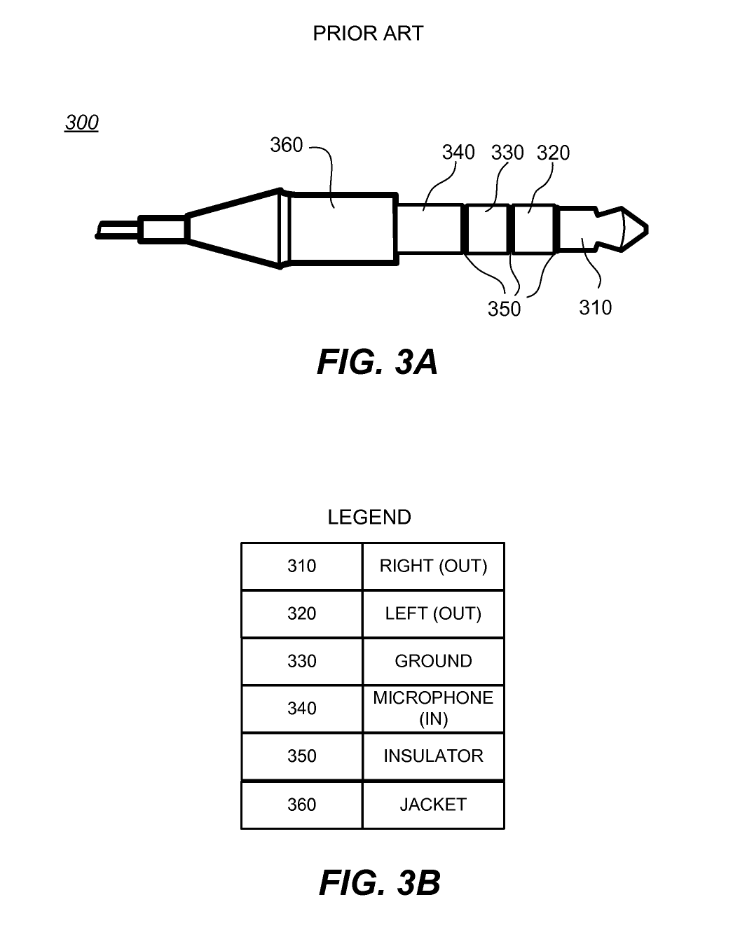

FIG. 3 is an illustration of a typical four conductor plug 300, for use in a smart device. This type of plug 300 may sometimes be referred to as a TRRS plug, having a tip 310 for sound out (right), section 320 for sound out (left), section 330 for ground, and section 340 for sound in (microphone), all separated by insulator 350. Jacket 360 is provided at the wire-side end to support the electrical-to-mechanical connection of the respective wires (not shown). Sound out (310, 320) sections tap into the smart device's output signal which is an analog sinusoidal output signal (for a sound output) of up to 15 mW which is enough to drive to drive headphones/speakers to a high volume. Of course, some smart devices may have more or less power coming out of the respective jack.

The fact that the sound out sections 310, 320 receive a signal from the smart device with an equivalent power of up to 15 mW (variable depending on smart device specifications) can be utilized, recognizing the output signal as a source of power, rather than just to drive headphone speakers. Also, sound in section 340, which is typically analog, can be understood to be used as a data input port, not only limited to speech. These facts will be explored in more detail in the following description.

It should be noted that while plug 300 is shown as having four contacts, other plugs having more or less contacts may be used. For example, a monaural plug having only three contacts may be used: mono out (for example, combining Left and Right), sound in (microphone) and ground. Further, it is known that some plugs may have five or more contacts, which may be utilized. For example, in some plug configurations, the sound out connections may be supplanted by a DC out line that is provided by the smart device as a source of power specifically designed for devices that are connected to the smart device's “ear phone” jack. In this event, sound-to-high power conditioning steps illustrated below may be obviated or accordingly modified, according to design preference. As one specific example, a five (or more) contact plug is contemplated that has a dedicated DC 40 V (or other voltage value) output for secondary device powering.

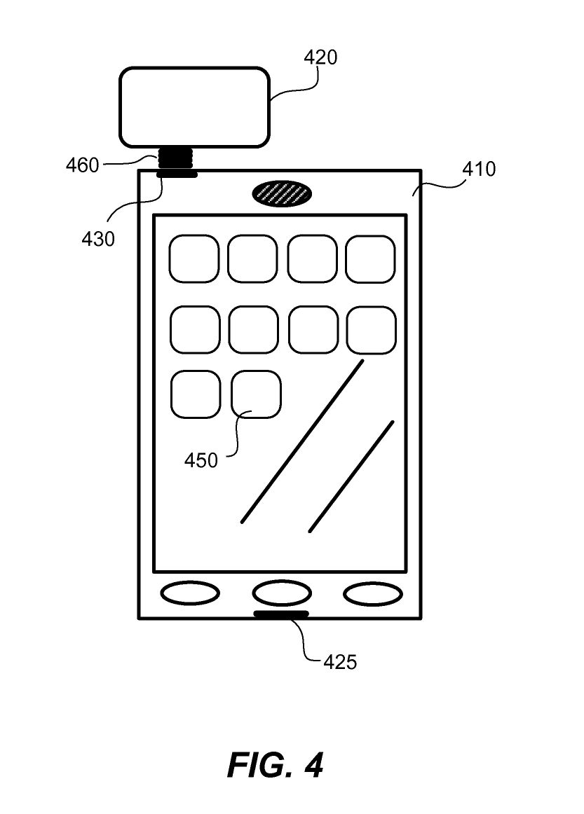

FIG. 4 is an illustration of an exemplary radiation detector module 420 installed into a smart device's 410 “headphone” jack 430. Applications or software 450 for controlling the exemplary radiation detector module 420 can be installed on or operated from the smart device 410. FIG. 4 demonstrates one possible configuration using exclusively the smart device's 410 “headphone” jack 430 as the port of entry for the exemplary radiation detector module 420. The headphone jack 430 provides both a very robust mechanical connection and also electrical connections to the exemplary radiation detector module 420. The symmetrical shape of the inserted plug (hidden from view) may enable the exemplary radiation detector module 420 to “rotate” to a preferred direction, if needed, or the jacket 460 may be shaped to prevent movement (i.e., rotation) of the exemplary radiation detector module 420. In some embodiments, the jacket 460 may be shaped to actually facilitate controlled movement of the exemplary radiation detector module 420, that is, it may allow it to rotate to a specific angle, as according to design preference.

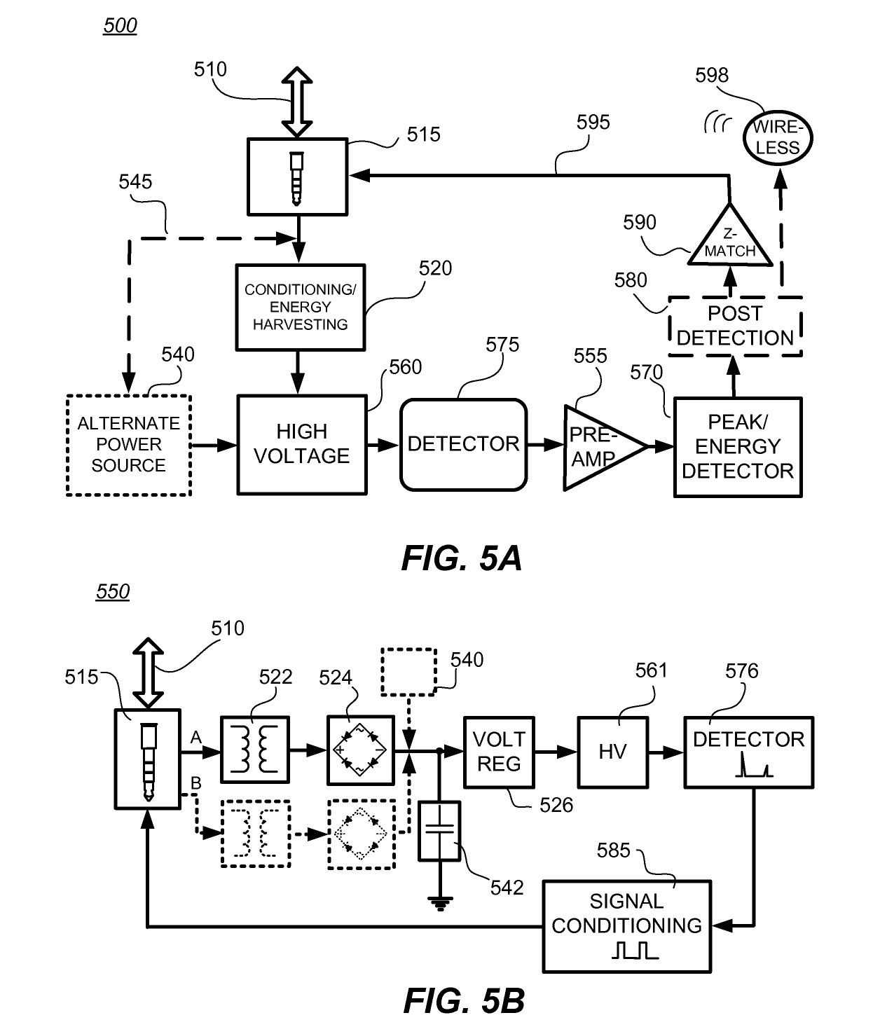

FIG. 5A is a block diagram of an exemplary radiation detector circuit 500 layout. Recalling that power (and/or data) can be tapped from plug 515, power in the form of an electrical “sound” signal 510 can be conditioned to a more useable form via conditioning/energy harvesting module 520. That is, incoming electrical “sound” signal 510 will typically be non-DC (aka AC) and limited to a specific frequency range and voltage amplitude. Typically, the AC signal will need to be converted to a DC signal to drive the respective devices in the exemplary system 500. The conditioning/energy harvesting module 520 operates to convert the incoming form of energy into a detector-usable form. This can simply be a rectifying circuit that provides a DC or DC-like conversion of the AC electrical “sound” signal 510 to feed High Voltage module 560, which provides the sufficient level of voltage/energy to operate radiation Detector 575. To maximize the amount of power/voltage provided from electrical “sound” signal 510, it is recommended (though not necessary) that higher frequency sound be “output” from the smart device (not shown) into plug 515 as well as higher volume. Of course, an optimal output signal would be in the form of a square wave (best suited for rectification). However, it is understood that depending on the input power/signal requirements of radiation Detector 575 and High Voltage module 560, other values than the highest frequency/volume or non-square wave output may be used, according to design preference.

As stated above, in some embodiments, the plug 515 configuration may be such that it contains a dedicated DC power out contact. Therefore, in this situation, the output “sound” signal may not utilized for powering the exemplary radiation detector, but rather the dedicated DC power out from the associated contact; and the conditioning/energy harvesting module 520 may be obviated altogether.

For example, for a Cadmium zinc telluride (CZT), or variations thereof, radiation detector, the operating voltage is somewhere between 300-1,000 Volts, which is not possible by the smart device (recognizing the maximum output voltage from the smart device is about 5 V)—requiring High Voltage module 560 to step-up the smart device's output power to the 300-1,000 V range. Of course, other radiation detector types may require different voltage (or current) amounts, therefore, High Voltage module 560 may have different “step-up” values. It is also noted that some detector types require not only a high voltage but also a reasonable amount of current (i.e., high power). In these instances, the conditioning/energy harvesting module 520 and High Voltage module 560 may enable both a high voltage output and a reasonable (e.g., relatively high) current output.

It is expressly understood that Detector 575 may be a non-CZT detector. For example, it may be any one or more of a semiconductor-based detector, a scintillation-based detector, a gas-based detector, a hybrid or any other now known or later devised detecting mechanism. Some possible non-limiting examples are: Geiger, neutron, H³, scintillator, PIN photodiode, gas, photo-multiplier, and so forth. In the embodiment shown here, it is implied that the High Voltage module 560 requires DC power input. In some embodiments, the High Voltage module 560 may utilize AC power and, accordingly, conditioning/energy harvesting module 520 may not need to rectify the incoming electrical sound signal 510.

While it is contemplated that all power for the exemplary system 500 may arrive from the plug 515, it may be desirable, in some instances, to have a complementary power source 540 to supplement or provide full power to the various devices, as needed. This approach may be necessary if the upper power limit of the incoming electrical “sound” signal 510 is insufficient to properly power the High Voltage module 560. Signal line 545 provides one possible pathway indicating the possibility of the alternate power source 540 both acting as a charge receiver (charged from power from the plug 515) and as a charge returner, providing power to the conditioning/energy harvesting module 520, if needed, or directly to the High Voltage module 560.

Upon sufficient powering, radiation Detector 575 will operate and provide radiation values or some output signifying the detected radiation. Typically, but not always, the output will be a transient peak function. This output is amplified by Pre-amp 555, which then is detected by Peak Detector 570, which detects peaks of the detected radiation (some Peak Detectors 570 may also detect energy level, time constant, frequency, etc.). The output of Peak Detector 570 is forwarded to an optional Post-Detection conditioning module 580, which may do some averaging, signal correlation, and any other form of conditioning and/or processing. The conditioning may include amplifying, if necessary. In any event, output from Peak Detector 570, in one form or another, is forwarded to impedance matcher 590, so as to properly match the impedance output of Peak Detector 570 (or Post-Detection conditioning module 580) via pathway 595 to plug 515 into smart device's (not shown) input jack's impedance.

Optionally, a wireless mode 598 of communicating is provided to a smart device, bypassing or supplementing communication via plug 515. In this last example, it is envisioned that some ancillary information from Peak Detector 570 (or any other device in the exemplary system 500) may be forwarded via wireless mode 598 to the smart device, while raw count/peaks are forwarded via plug 515. As some non-limiting examples, the wireless information may be spectral information/type of radiation/amount of energy of the radiation, etc. Further, health and status checks could be performed wirelessly, both as to forwarding information to the smart device or receiving information/commands from the smart device to the exemplary system 500.

In embodiments where a non-wireless version is envisioned, commands, data, and so forth may be communicated “into” plug 515 via the exemplary system 500, where different amplitudes of the output of Peak Detector 570 (and/or Post-Detection conditioning module 580) could signify the energy level of the detected radiation. Continuing, other variations could include different output frequencies to signify the type or amount of radiation, or modulations thereof. Multiple coding mechanisms (for example, phase, frequency, etc.) could be utilized (as facilitated by Post-Detection conditioning module 580—which would have some coding or processing capability, or even memory) to have tones generated to signify information/data to be received by plug 515. For example, tones analogous to a facsimile or other sound-based coding scheme may be used to convey information to plug 515. Therefore, understanding that audio-based communications is a vast field, modifications to the configuration and type of signal forwarded to plug 515 may be contemplated without departing from the spirit and scope of this disclosure.

It should be noted that the exemplary radiation detector circuit 500 layout, as shown, does not need to be “digital” in form. That is, the entire range of devices shown may be analog, if so desired. An advantage of an entirely analog detector system is that expensive digital circuits (specifically A/D converters or CPU/processors) are not necessary. This enables the construction of a very inexpensive radiation detector, as compared to the prior art radiation detector systems. Of course, it may be desirable in some embodiments, to have digital circuits, according to design and performance requirements.

FIG. 5B is a block diagram 550 showing the specifics of another exemplary radiation detector circuit layout, suited for a Geiger counter implementation. Here, general conditioning/energy harvesting module 520 of FIG. 5A may be replaced/supplemented with transformer 522 and rectifying circuit 524. The transformer 522 can also act as an impedance matching circuit, if so needed. Due to the possibility of different voltage output levels from plug 515, in some smart devices, the power signal from one output channel (A->L or B->R) may be of sufficient amplitude to provide the necessary power for the exemplary radiation detector. For example, in Apple® products, the L channel was found to provide ample power for various experimental models fabricated by the inventors. In Android® products, both the L and R channels were used to acquire the desired power levels. Therefore, depending on the smart device utilized, the power signal may be of insufficient amplitude and therefore additional power can be tapped from the secondary path B->R channel, shown here in dashed lines. It is noted here that, in some embodiments, plug 515 may be configured to have a dedicated DC output voltage contact, as earlier discussed above, for the given type of smart device. In this scenario, respective transformer 522 and/or rectifying circuit 524 may be circumvented or eliminated.

Continuing, prior to High Voltage module 561, a Voltage Regulator 526 may be instituted to regulate the rectified output of rectifying circuit 524. Capacitor 542 or equivalent can be shunted before Voltage Regulator 526 to store the charge coming out of the rectifying circuit(s) 524. Alternate/independent power 540 may also be provided to Voltage Regulator 526. The High Voltage module 561 provides sufficient power to Detector 576 for its operation, illustrated here as detecting two hits. After detection, Signal Processing/Conditioning/Matching module 585 can be instituted, altering the signal from Detector 576 to a form that is more recognizable—illustrated here as a pulse representations of the two hits, noting that the energy levels of the detected hits are not translated in Signal Processing/Conditioning/Matching module 585.

The output of the Signal Processing/Conditioning/Matching module 585 can be forwarded to plug 515 wherein software operating in the smart device (not shown) can perform the chore of converting the pulses into a count or measure of the detected radiation. It is noted here, that this particular approach envisions the “count” to be performed at the smart device side, rather than at the exemplary radiation detector side. That is, the task of “recognizing” that something (i.e., radiation) has been detected and an accounting thereof can be off-loaded to the smart device. If matching plug 515 impedance is significant, the “matching” aspects of Signal Processing/Conditioning/Matching module 585 may be in a separate module.

Due to the fact that energy levels are not captured by this approach, this embodiment is well suited for Geiger counter applications. Of course, modifications may be made to this embodiment wherein the count can be performed on the exemplary radiation detector side, without departing from the spirit and scope herein.

Various specific details to actual hardware utilized to fabricate an experimental Geiger counter are presented. In one exemplary embodiment, transformer 522 is achieved by CoilCraft's Model 252P, rectifying circuit 524 by a network of generic diodes Model CDBUO130L, and capacitor 542 is obtained with a 152 μF capacitor. The Voltage Regulator 526 is accomplished with MAXIM model MAX8881 and High Voltage module 561 is formed from a charge pump (e.g., voltage multiplier) using a network of generic Model 1N4148 diodes, and 0.1 μF capacitors. Feedback is implemented from Detector 576 to High Voltage module 561 to control the amount of voltage to High Voltage module 561 using a MAXIM model MAX4162 amplifier configured to operate as a pulse width modulation (PWM) circuit control circuit.

MAXIM Model MAX4162 is connected to a current buffering chip generic model SN74HC14, which in turn is connected to a generic power field effect transistor (FET) capable of providing 100 mA of current. The FET feds the charge pump of High Voltage module 561 using a 4.7 μH inductor connected to the drain of the FET (the FET can also be part of PWM feedback/control process).

Detector 576 is a Geiger-Müller tube model SBM20 (or STS5) and signal conditioning is achieved with a saturated transistor generic model MMBT3904, connected to a LM555 chip configured as a monastable multivibrator. The output of the LM55 chip is coupled to plug 515.

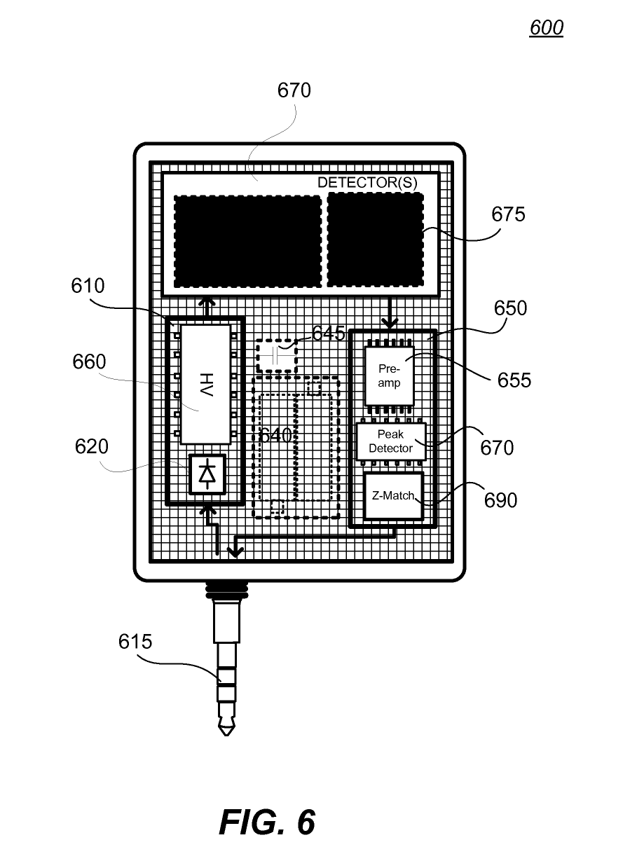

FIG. 6 is an “inside” illustration of an exemplary radiation detector 600, showing the principal circuit modules of FIG. 5. For example, module 610 is shown containing a rectifying circuit 620 coupled to High Voltage module 660, which are coupled to plug 615—presumably feeding audio power to rectifying circuit 620. Optional battery 645 and optional charging capacitor 645 are shown as alternate power source. Detector module 670 shows one or more radiation detectors 675. It is noted in some embodiments, the radiation detector(s) 675 may be sensitive to orientation, whereas the radiation detector(s) 675 may be positioned in detector module 670 in a preferred direction. For example, there may be multiple detector modules 670 displaced around an exemplary radiation detector 600. Multiple detectors in different configurations may be used, according to design preference. Moreover, different types of detectors may be used. The output of the detector module 670 is fed to post-detection module 650 which contains pre-amp 655, peak detector 670 and impedance matcher 690. Output of post-detection module 650 may is fed to into plug 615's microphone contact.

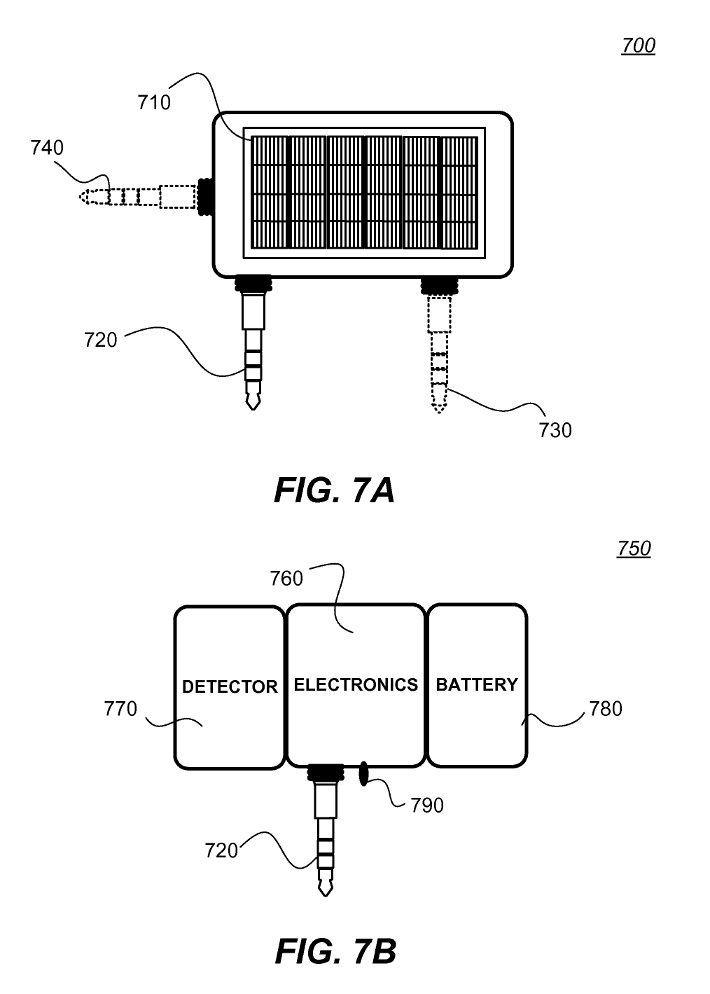

FIGS. 7A-B are illustrations of possible variations of exemplary radiation detectors 700 and 750. FIG. 7A illustrates an embodiment with a solar cell/panel 710 operating as one form of alternate power source or as a power supplement. Plug 720 is shown pointing downward, but other locations may be implemented, as illustrated by plug locations 730 and 740.

FIG. 7B is an illustration of a modular configuration 750. Specifically, the actual radiation detector portion 770 (corresponding, for example to FIG. 6's detector module 670) is separate from electronics module 760 and alternate power source/battery module 780. Each of these modules can be “connected” to each other enabling a high degree of versatility. For example, in one scenario a Geiger counter may be needed, thus radiation detector portion 770 may be switched out from a CZT-type detector or a Geiger counter type detector, and so forth. Additionally, battery module 780 may have a specialized battery source that can provide sufficient enough power to power the radiation detector portion 770. In some scenarios, the battery source may contain the High Voltage module (not shown) that is appropriate for the respective radiation detector portion 770. To control the rotational/axial motion for the modular configuration 750, a fastener or clip 790 is shown. When inserted into a jack, fastener or clip 790 (or some variation thereof) can be used to prevent the electronics module 760 from rotating—fixing the orientation of attached radiation detector portion 770. Of course, not shown, the mechanism for connection between the various modules should permit data/signal communication and power. In some embodiments, the mechanism for connection may allow some degree of swiveling, if so desired. For example, it may be desirable to have radiation detector portion 770 swivel to a desired direction.

Given the above, various modification and changes may be made without departing from the spirit and scope of this disclosure. For example, the above modules may be combined, as deemed appropriate. For example, radiation detector portion 770 and battery module 780 may be combined, as well as other combinations.

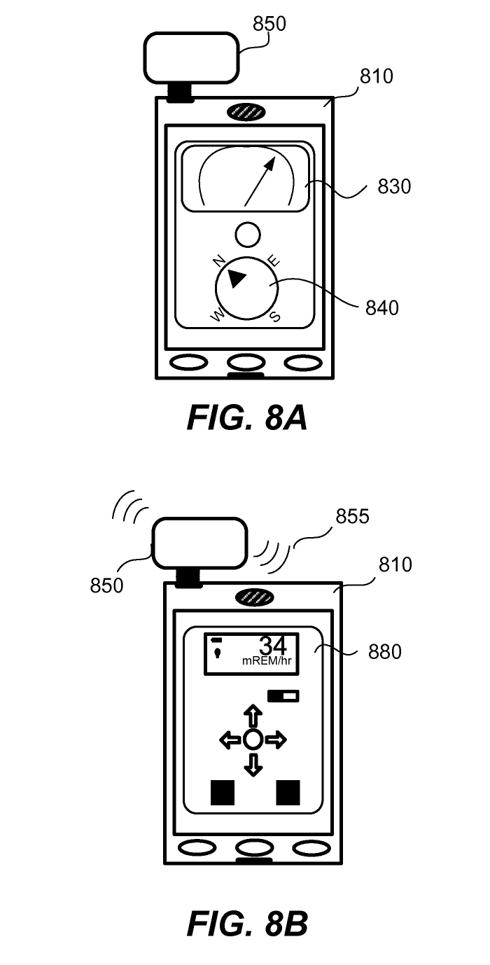

FIGS. 8A-B are illustrations of smart devices in operation with an exemplary radiation detector(s) 850 plugged into the smart devices 810. FIG. 8A illustrates smart device 810 running a Geiger counter application 830 with an orientation 840 sensitivity. FIG. 8B illustrates smart device 810 running a standard radiation intensity counter application 880. However, data from exemplary radiation detector 850 is shown (as one possible example) being communicated via Bluetooth (or other wireless scheme) to smart device 810. It should be understood that exemplary radiation detector 850's wireless communication may be to other devices (not shown).

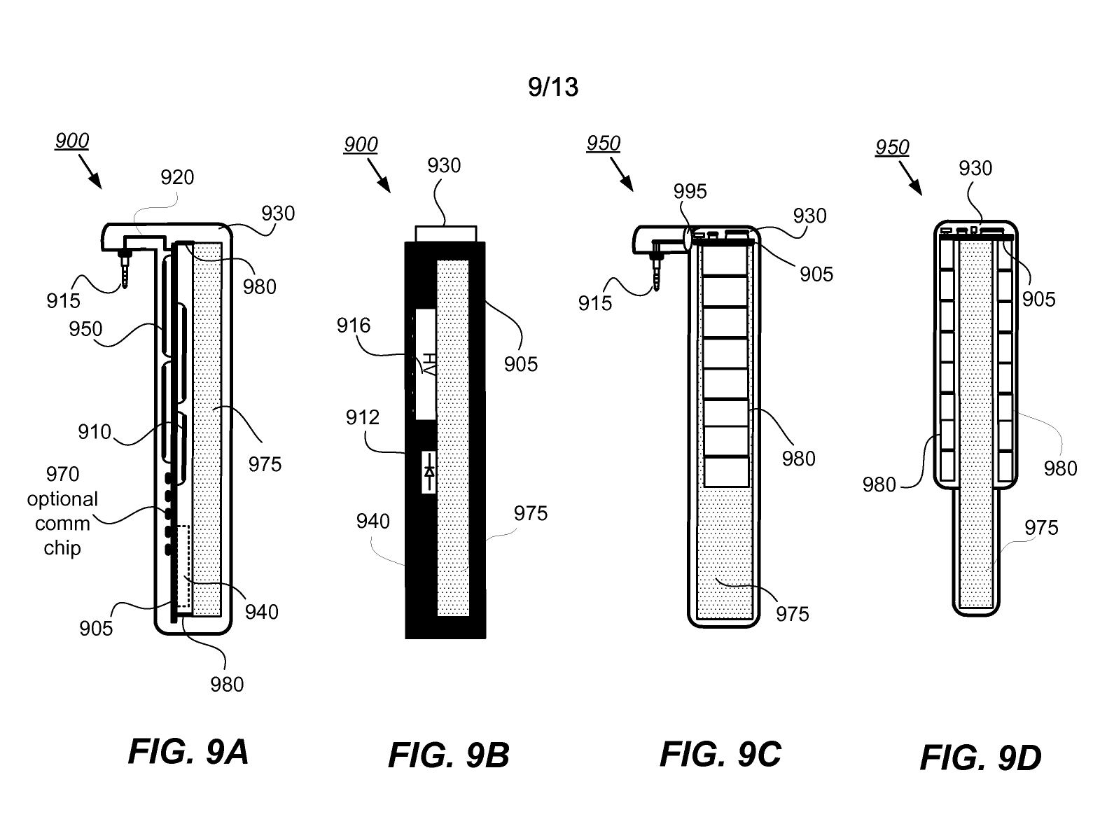

FIGS. 9A-D are illustrations of other configurations for an exemplary radiation detector. FIG. 9A is a cross-sectional side view of an exemplary radiation detector 900 that is configured for attachment to the rear of a smart phone/device (not shown). This configuration is for a larger detector assembly is and is illustrative of what may be used for a gas-based (Geiger) detector system—the longer form factor being necessitated by the size of a conventional Geiger-Müller tube. The exemplary radiation detector housing 930 protects detector 975 which is attached or coupled to vertical printed circuit board 905 via connections 980. The printed circuit board 905 supports multiple chips 910 and 950 and optional communication chip (for wireless communication) 970. Optional battery 940 is also supported by printed circuit board 905. Of course, various elements described above may be supported through housing 930, rather than through printed circuit board 905. Plug 915 is disposed on the “front” of housing 930 and is connected to the various systems via line 920.

FIG. 9B is cut-away illustration of the rear of the exemplary radiation detector 900. Upper housing section 930 bridges to jack 915 (not shown). HV circuit 916 and rectifier 912 are shown on printed circuit board 905, with gas-based detector 975, and optional battery 940, thereupon. Additional devices/circuits are understood to be obscured from view either by detector 975 or by printed circuit board 905. Evident from these FIGS. is that the form factor of the exemplary radiation detector 900 may vary depending on the size of the components needed. In any event, the exemplary radiation detector 900 is sized to conveniently mate onto a smart phone/device's jack port without significantly encumbering the smart device.

FIGS. 9C-D are cross-sectional side and rear views, respectively, of another exemplary radiation detector 900 that is configured for attachment to the rear of a smart phone/device (not shown). The principal difference in these FIGS. from FIGS. 9A-B is that printed circuit board 905 is horizontally placed “on top” of the detector 975. This allows direct circuit contact to the top of the detector (tube) 975. Further, the respective circuits can be mounted to the top section of the housing 930. Another important difference, illustrated here, is that banks of impedance matching transformers 980 are utilized in this embodiment, which are situated on the “sides” of the detector 975. In experimental models fabricated by the inventors, a significant number of matching transformers/impedance matchers were found to be necessary for the particular type of detector 975 used (Geiger-Müller tube SBM-20). Also, as seen in FIG. 9C, a swiveling mechanism 995 can be utilized to allow the entire assembly to swivel in a lateral direction and/or vertical direction, if so needed.

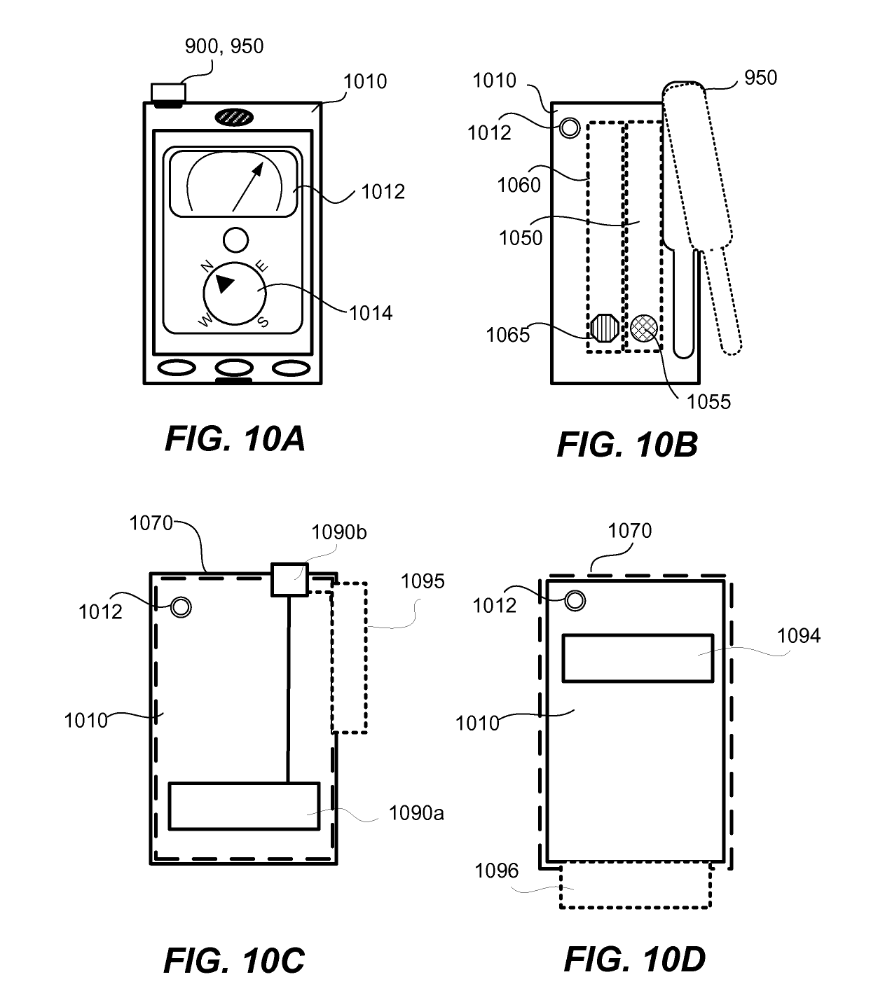

FIGS. 10A-D are illustrations of various exemplary radiation detectors and their possible form factors, as-connected to smart devices. FIG. 10A is a front view illustration of the exemplary radiation detector 900, 950 of FIGS. 9A-D attached to a smart device 1010, showing a Geiger counter application 1012 with orientation 1014 sensitivity.

FIG. 10B is a back view illustration showing the exemplary radiation detector 950 of FIGS. 9C-D attached to the smart device 1010 having a built-in camera 1012. It is noted that the dashed outline of the detector 950 illustrates one mode where it is “swiveled” away, as discussed above. It is noted that multiple other devices 1050, 1060 may be attached to the exemplary radiation detector 950. For example, device 1050 may contain a speaker 1055 to allow audible feedback and/or audio communication capabilities. Device 1060 may contain an ultrasonic speaker 1065 for non-audible communication (for example, to other detectors, systems, monitors, etc.). It is worthy to note that this embodiment illustrates an “expandable” set of features that can be connected to the exemplary radiation detector 950 (900), to augment or to enhance the underlying capabilities. Modes for mechanical-electrical attaching/connecting are well known in the art and therefore are not elaborated herein.

FIG. 10C is a back view illustration showing different form factors and arrangement/configurations for an exemplary radiation detector attached to a smart device 1010 with a camera 1012, via a device case 1070. In particular, sensor/detector element 1090a may be displaced from jack assembly 1090b, and may be situated on a lower (other) portion of the smart device 1010. Another optional configuration is shown, wherein sensor/detector element 1095 is situated to the “right” of the smart device 1010, being coupled to the jack assembly 1090b. It is noted that various versions of this embodiment contemplate the exemplary radiation detector as being part of the case 1070 or affixed to the case 1070.

FIG. 10D is a back view illustration with a self-powered radiation detector 1094 that is situated to the back of the smart device 1010 having built-in camera 1012, via case 1070. The self-powered radiation detector 1094 may be charged/operated by solar energy, mechanical motion, magnetics, battery powered, and so forth. Using a Bluetooth or wireless connection (not shown), the exemplary self-powered radiation detector 1094 can communicate with the smart device 1010. In variations of this embodiment, the self-powered radiation detector 1094 may have a jack or connector (not shown) that is used to “charge” the self-powered radiation detector 1094 into an operation-capable mode (for example, using a battery, capacitor, etc., in the self-powered radiation detector 1094). Upon completion of the charging, the self-powered radiation detector 1094 can be “unjacked” and situated as shown in FIG. 10D.

FIG. 10D also shows another configuration where the exemplary radiation detector 1096 is attached to a non-headphone jack connection at the bottom of the smart device 1010, utilizing the non-headphone jack capabilities for powering/communication/etc. Of course, depending on the location of the port utilized (USB, iPod®, etc.), the exemplary radiation detector 1096 may be attached to the smart device 1010 at different port locations.

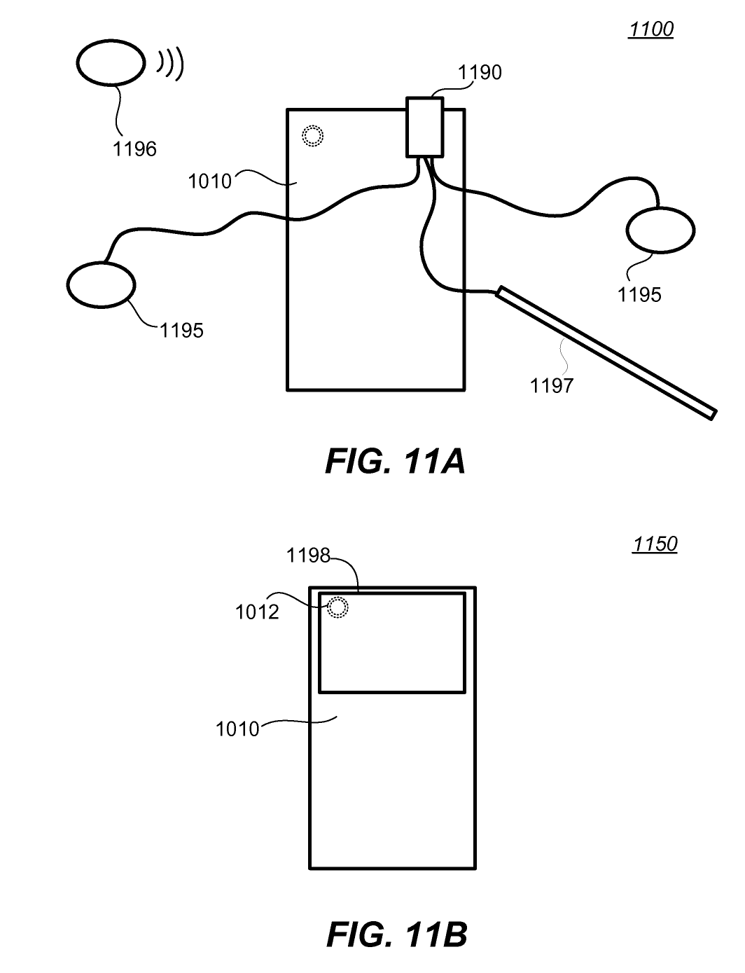

FIGS. 11A-B are illustrations of other exemplary radiation detectors. FIG. 11A illustrates one embodiment 1100 where the “sensor” elements 1195, 1196, 1197 are detached via cables/lines and/or wireless connections. Sensors 1195 illustrate cabled sensors that are connected to jack connecting assembly 1190. In some embodiments, the jack connecting assembly 1190 can contain the necessary electronic components to convert and/or power the sensors 1195, 1196, 1197. This embodiment contemplates the ability to couple multiple sensors to an exemplary radiation detector, but allowing the sensors to be remotely positioned from the smart device 1010. Further, with this added flexibility, different types of sensors may be utilized. For example, sensor 1197 is shown as a wand-like sensor which can easily accommodate a gas-based detector, for example, as well as allow the user to position the detector in hard to reach areas. Wired sensors 1195 can be positioned on a person's body, for example the legs or arms, or any other place. Wireless sensor 1196 can also be situated on a person's body or elsewhere. Wireless sensor 1196 can convey it's “sensed” information to the smart device 1010 or can communicate with another device, if so designed.

While FIG. 11A illustrates three cabled sensors and one wireless sensor, it should be understood that more or less sensors may be utilized, depending on design and engineering implementation. Moreover, different shaped, types, form factors and modes of coupling, communicating, attachment, and so forth may be contemplated without departing from the spirit and scope of the embodiments described herein.

For example, FIG. 11B illustrates one exemplary embodiment 1150, wherein the sensor 1198 “communicates” via the smart device's 1010 camera 1012 lens interface—that is, using light as a means of communication. In other embodiments, the sensor 1198 may be optically responsive to radiation and directly communicate via a proportional light input into the camera 1012 lens. For example, a scintillating material may act as a “detector” and the ensuing light generated by the scintillating material may be captured by the camera 1012 lens. The sensor 1198 may be directly affixed to the smart device 1010 or via a case (not shown).

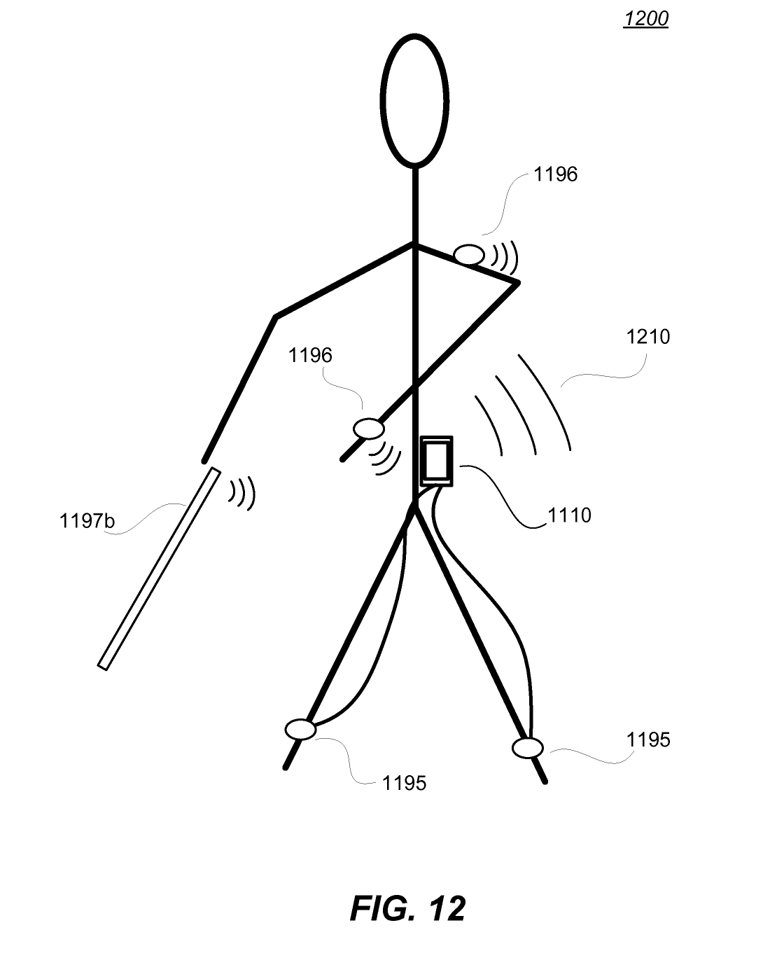

FIG. 12 is an illustration 1200 of an exemplary radiation detector with sensors deployed on a person's body. Smart device 1110 with an exemplary radiation detector (not shown) interfaces with sensors 1195, 1196, 1197b which are positioned around different portions of a user. Sensor 1197b differs from sensor 1197 of FIG. 11B in that it incorporates a wireless mode of communication. Further, as indicated by sensor 1196, the wireless communication does not need to be restrained to the smart device 1110, but can communicate to another smart device (not shown). By allowing the sensors to be at the extremities of the user, greater “protection” and detection can be achieved.

It should be appreciated that with multiple sensors, greater “sensitivity” may be acquired by integrating the overall reception over the coverage area. Further, some of the sensors may be directionally sensitive (for example, the wand-like sensor 1197b may be end-sensitive, if so desired), allowing scanning type scenarios.

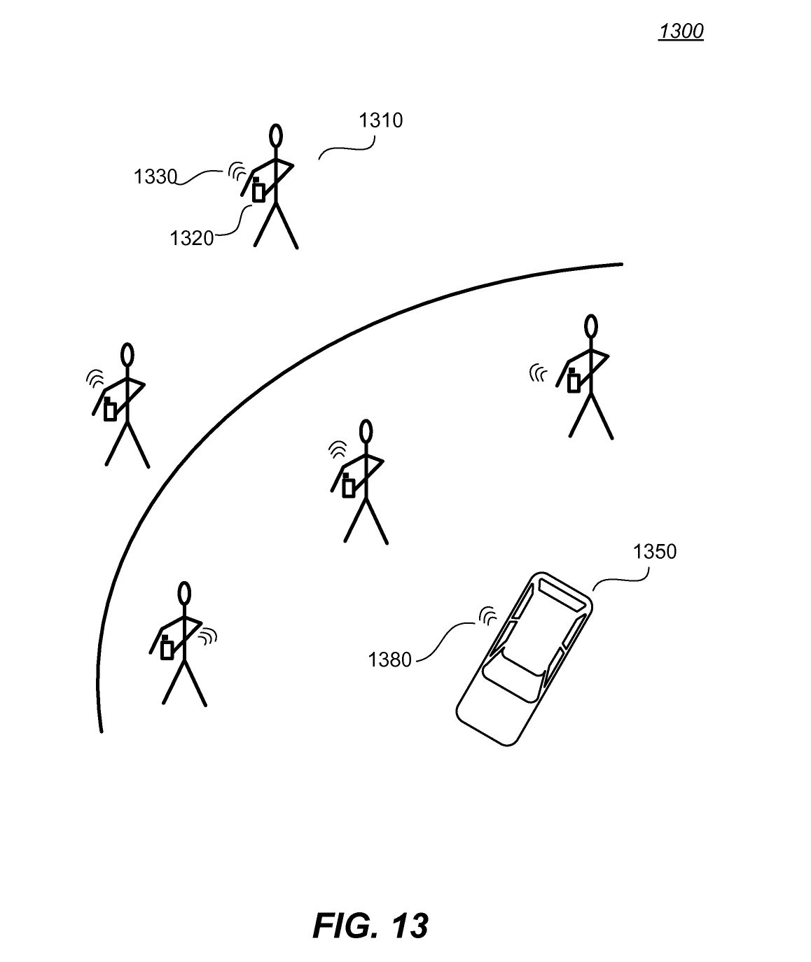

FIG. 13 is an illustration of a geo-locating scenario utilizing exemplary radiation detector systems with smart devices 1320. Recognizing that smart devices 1320 (particularly mobile phones) have geo-location capabilities, the efficient and cost effective geo-mapping of radiation can be accomplished, utilizing the cellphone signals 1330 (or wi-fi signals or radio signals) inherently available in most smart devices. Due to the portability of smart devices 1320 and the potential for the exemplary radiation detectors' 1320 to be significantly lower in cost than competing systems, they can be widely deployed. Due to the smart devices mobile nature, they (and the exemplary radiation detectors 1320 may be hand-carried or used even in automobiles 1350 or other modes of transportation (not shown) allowing very quick and accurate coverage of area.

It will be understood that many additional changes in the details, materials, steps and arrangement of parts, which have been herein described and illustrated to explain the nature of the invention, may be made by those skilled in the art within the principle and scope of the present disclosure.

What is claimed is:

1. A radiation detector, capable of being plugged into a portable smart device's headphone/microphone jack, comprising:
a housing;
a headphone/microphone plug, extending from the housing, having at least sound-out, ground, and sound-in contacts;
an audio signal conditioning/rectifying circuit coupled at least to the sound-out and ground contacts;
a high voltage source coupled to an output of the audio signal conditioning/rectifying circuit;
a radiation sensor coupled to an output of the high voltage source;
a pre-amplifier coupled to an output of the radiation sensor;
an energy detector coupled to an output of the pre-amplifier; and
an impedance matcher coupled to an output of the energy detector, wherein an output of the impedance matcher is coupled to the sound-in contact of the headphone/microphone plug.

2. The radiation detector of claim 1, further comprising at an independent power source coupled to an input of at least one of the audio signal conditioning/rectifying circuit and the high voltage source.

3. The radiation detector of claim 2, wherein the independent power source is rechargeable.

4. The radiation detector of claim 1, further comprising a post detection/conditioning module coupled to an output of the energy detector.

5. The radiation detector of claim 4, wherein the post detection/conditioning module contains at least one of an amplifier, a processor, and a memory.

6. The radiation detector of claim 4, further comprising a wireless communication module coupled to the output of at least one of the energy detector and post detection/conditioning module.

7. The radiation detector of claim 1, wherein all of the elements are analog devices.

8. The radiation detector of claim 1, wherein the radiation sensor is at least one of a CZT, Geiger, neutron, H³, scintillator, PIN, gas, and photo-multiplier sensor.

9. The radiation detector of claim 1, further comprising a smart device, wherein the radiation detector is plugged into the smart device via the smart device's headphone/microphone jack.

10. The radiation detector of claim 9, further comprising a smart device radiation detector application, running on the smart device and interfacing with data from the radiation detector.

11. The radiation detector of claim 9, wherein the radiation detector is mounted on a back portion of the smart device.

12. The radiation detector of claim 1, wherein the radiation sensor is adapted to be coupled to a secondary device, the secondary device mating to a portion of the housing.

13. The radiation detector of claim 1, wherein the secondary device contains a speaker.

14. The radiation detector of claim 1, wherein the housing is in at least two separate independent pieces.

15. The radiation detector of claim 14, wherein one of the two separate housing pieces contains the headphone/microphone jack and wherein the other of the two separate housing pieces contains the radiation sensor.

16. The radiation detector of claim 1, wherein there are a plurality of radiation sensors.

17. The radiation detector of claim 16, wherein at least one of the plurality of radiation sensors is in a housing substantially shaped as a wand.

18. A portable radiation detection system, comprising:
a plurality of radiation detectors capable of being plugged into a portable smart device's headphone/microphone jack, each radiation detector comprising:
a headphone/microphone plug, extending from the housing, having at least sound-out, ground, and sound-in contacts;
an audio signal conditioning/rectifying circuit coupled at least to the sound-out and ground contacts;
a high voltage source coupled to an output of the audio signal conditioning/rectifying circuit enclosed;
a radiation sensor coupled to an output of the high voltage source;
a pre-amplifier coupled to an output of the radiation sensor;
an energy detector coupled to an output of the pre-amplifier; and
an impedance matcher coupled to an output of the energy detector, wherein an output of the impedance matcher is coupled to the sound-in contact of the headphone/microphone plug;
a plurality of smart devices, wherein each of the plurality of radiation detector is plugged into each of the plurality of smart devices; and
a radiation detector application running on each of the plurality of smart devices.
